(19) United States
(12) Patent Application Publication
(10) Pub. No.: US 2012/0224365 A1
(43) Pub. Date: Sep. 6, 2012

(54) LIGHT EFFICACY AND COLOR CONTROL SYNTHESIS

(76) Inventor: Yigal Yanai, Givatayim (IL)

(21) Appl. No.: 13/508,547

(22) PCT Filed: Nov. 18, 2010
(86) PCT No.: PCT/IB10/55274

§ 371 Date: May 8, 2012

(30) Foreign Application Priority Data
Nov. 19, 2009 (US) 61262558

(51) Int. Cl. F21V 9/00

(52) U.S. Cl. 362/231

(57) ABSTRACT

An illumination system comprising of at least one fast response light source of each of at least two different colors, and a mechanism for activating the light sources alternately is disclosed. The illuminations system generates a train of pulses of that at least two different colors, the pulse train having a frequency above 350 Hz, a duty cycle in the range of 5% to 80%, a predefined sequence of pulses of the at least two different colors within a predefined time period. Furthermore, a method for synthesizing a light color is provided. The method comprising providing fast response light sources of a least two different colors, defining a train of pulses having a frequency above 350 Hz and a duty cycle in the range of 5% to 80%, defining a time period and an activation sequence for activating the at least two different colors alternately, and activating the fast response light sources to emit the train of pulses according to the time period and the activation sequence.

### FIELD OF THE INVENTION

The invention relates generally to light sources, and more particularly to synthesis of light color with high quality and high illumination efficacy.

### BACKGROUND OF THE INVENTION

The eye retina consists of a large number of photoreceptor cells which contain Opsin molecules. Opsin is the universal photoreceptor molecule of all visual systems. Opsin molecules change their conformation from a resting state to a signaling state, insensitive to further light absorption, and return to their initial resting state after some characteristic time. Due to the Opsin photoreceptor molecules light absorption cycle, the visual system has a slow response time, and the retention of the human visual system is exploited for example by the movies industry where projecting a rapid sequence of pictures creates an illusion of movement.

The visual system codes the color of an image using three types of Opsin molecules that differ in the light wavelength they respond to optimally (bluish, greenish and reddish Opsin molecules). Accordingly, the visual system codes the color of an image concurrently.

White or any other color can be formed by mixing colored lights. The most common method is to use red, green and blue (RGB) light sources simultaneously. For example, white color may be produced by several types of multi-colored light emitting diodes (LEDs) activated simultaneously, such as di-, tri-, and tetrachromatic LEDs. Several key factors that play among these different methods include color stability, color rendering capability, and luminous efficacy. Often higher luminous efficiency implies lower color rendering, presenting a trade off between the luminous efficiency and the color rendering. For example, dichromatic white LEDs have the best luminous efficacy (120 lm/W) but the lowest color rendering capability. Conversely, tetrachromatic white LEDs have good color rendering capability, but often have poor luminous efficiency. Trichromatic white LEDs are in between, having mid values luminous efficacy (>70 lm/W) and mid values color rendering capability.

Thus, there is a long felt need to synthesize white light with high color rendering incex (CRI) and others light colors with high illumination efficacy using at least two different colors.

### SUMMARY OF THE INVENTION

Accordingly, it is a principal object of the present invention to overcome the disadvantages of prior art illumination systems. This is provided for in the present invention by an illumination system comprising of at least one fast response light source of each of at least two different colors, and a mechanism for activating the light sources alternately is disclosed. The illumination system generates a train of pulses of the at least two different colors, the pulse train having a frequency above 350 Hz, a duty cycle in the range of 5% to 80%, a predefined sequence of pulses of the at least two different colors within a predefined time period.

Furthermore, a mechanism for activating the light sources that includes (i) a pulse power supply for generating activating pulses to at least one fast response light source of each of at least two different colors, and (b) a control unit for managing the pulse power supply is provided.

Furthermore, the fast response light sources may be light emitting diodes and plasma light sources.

Furthermore, the illumination system may further comprise a phosphor-based white LED that is activated by the mechanism along with the fast response light sources.

Furthermore, the illumination system may have CRT greater than 90.

Furthermore, the illumination system may have energy saving gain factor proportional to the ratio of the activating pulses peak current to cycle average current.

Furthermore, the fast response light sources may be grouped in respective arrays and wherein the arrays of light sources are activated alternately.

Furthermore, an electronic device comprising the illumination system as a display system thereof is provided. The electronic device may be selected from the group consisting of televisions, computers, cellular phones and electronic game devices.

Furthermore, a method for synthesizing a light color is provided. The method comprising: providing fast response light sources of at least two different colors, defining a train of pulses having a frequency above 350 Hz and a duty cycle in the range of 5% to 80%, defining a time period and an activation sequence for activating said at least two different colors alternately, and activating the fast response light sources to emit the train of pulses according to the time period and activation sequence.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates an illumination system, according to embodiments of the present invention;

FIG. 2 illustrates a train of pulses, according to embodiments of the present invention;

### DETAILED DESCRIPTION OF THE PREFERRED EMBODIMENTS

Embodiments of the present invention enable synthesis of white light with high CRI and any other light colors with high illumination efficacy using LEDs or other fast response light sources.

Embodiments of the present invention exploit two important features of the visual system's Opsin molecules: a. Opsin photoreceptor molecules absorb light, trigger phototransduction cascade and remain insensitive to light for relatively long time period, and b. There are three different Opsin molecule types in the eye retina that code the color of an image.

According to embodiments of the present invention, the synthesis of any light color with high illumination efficacy may be achieved by high frequency (>350 Hz), low duty cycle trains of pulses. The train of electric current pulses activates fast response light sources of two or more different colors and has a predefined time period and sequence of activation of the fast response light sources.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

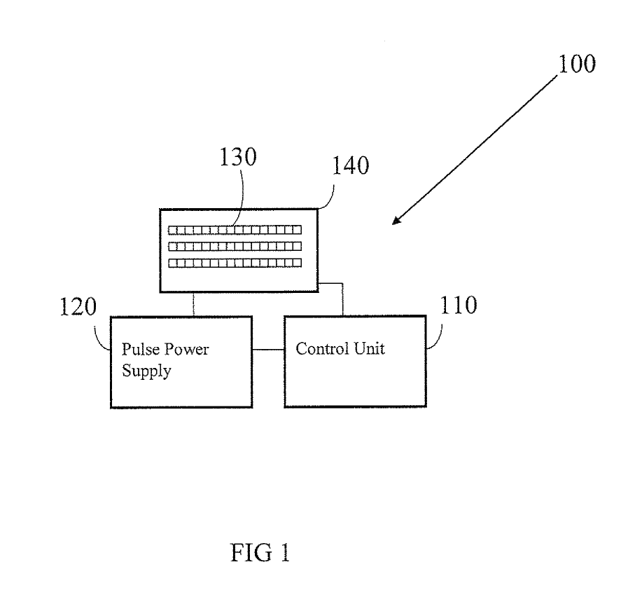

FIG. 1 illustrates an illumination system, according to embodiments of the present invention. Illumination system 100 includes a pulse power supply 110, a control unit 120, fast response light sources 130 of at least two different colors and an enclosure with at least one transparent surface 140. Illumination system 100 may be a lamp generating white or any other color light for indoor or outdoor usage. Illumination system 100 may be used to supply color information to any electronic device display of, for example, computers, televisions and cellular phones (as non-limiting examples).

Illumination system 100 is enclosed in an enclosure with at least one transparent surface. Pulse power supply 110 generates the activating trains of pulses to fast response light sources 130 and is managed by control unit 120. Fast response light sources 130 may be fast response light sources of at least two different colors such as (in the case of three different colors) red, green and blue (RGB) color LEDs, or other types of fast response light sources, such as plasma light sources. Pulse power supply 110 includes a mechanism for activating fast response light sources 130 alternately to generate a train of pulses of colored light. Fast response light sources 130 may be discrete light source units or arrays of light source units. Different sets of colors, other than the commonly used RUB, may be used to synthesize light color with high quality and high illumination efficacy according to embodiments of the present invention. Fast response light sources like LEDs and plasma sources turn on and off in less then 5 microseconds. Hence, in the appended claims, a “fast response” light source is a light source with a rise time of at most about 5 microseconds and a fall time of at most about 5 microseconds.

Control unit 120 manages illumination system 100 and in particular manages the sequence of pulses activating fast response light sources 130.

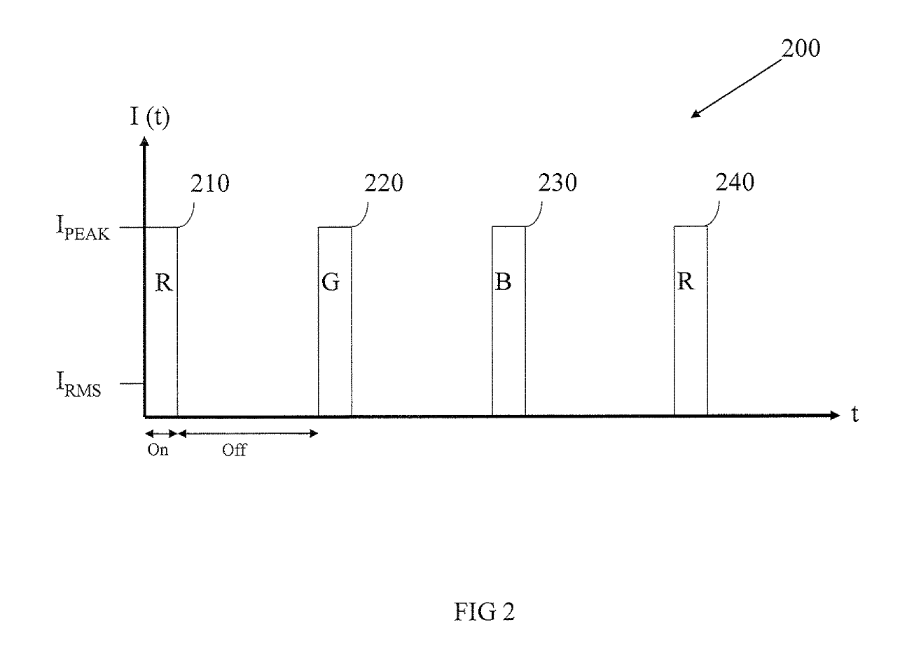

FIG. 2 illustrates a train of electric current pulses according to embodiments of the present invention. A train 200 of pulses may have, for example, a 5 KHz frequency (cycle time of 200 microseconds) and a 10 microsecond pulse width (a 5% duty cycle). Note that the cycle time and the pulse width recited above are given as an example only and are not limiting. Any frequency higher than 350 Hz may be used with the present invention. Note that the first pulse 210 activates a red color LED, the second pulse 220 activates a green color LED, the third pulse 230 activates a blue color LED and the forth pulse 240 activates again a red color LED.

Color rendering index (CRI) is a quantitative measure of the ability of a light source to reproduce the colors of various objects faithfully in comparison with an ideal or natural light source. According to embodiments of the present invention, the overall time period and the sequence of appearance of the different colored pulses (LED red, green and blue colors for example) may be changed by a person skilled in the art such that any desired visual color may be obtained. The synthesized light absorbed by a human eye may be composed of the three colored pulses in a sequence in a train of pulses. For example a pulse train period may be a pulse sequence of 100 high frequency pulses, composed of 37 activations of red color LED, 35 activations of green color LED and 28 activations of blue color LED. The activation of different color LEDs may be randomly distributed or in a predefined sequence within the pulse train period. Any color may be synthesized using various high frequency pulses (>350 Hz), low duty cycle, predefined pulse train period and predefined sequences of activation of different color LEDs. Advantageously, the frequency, the duty cycle, the predefined pulse train period and predefined sequences of activation of different colors light sources may be defined by persons skilled in the art in order to generate an energy-saving light source with high illumination efficacy.

According to embodiments of the present invention, the duty cycle may be in the range of 5% up to 80% of a cycle time. Due to the low duty cycle and to the fact that the visual system perceives a high frequency pulses train as continuous light source, a very high efficacy and energy saving illumination may be achieved. The average current drawn by the pulse power supplies in a cycle, I_{RMS} (shown in FIG. 2), is much lower than the pulse peak current, I_{PEAK} (shown also in FIG. 2). The ratio of the peak to average currents is a measure of the energy saving of the illumination system. At low pulses frequency, less than 350 Hz, the visual system operates as an energy averaging sensor and no power gain can realized by reducing the pulses duty cycle. At higher pulse frequency of 100 KHz and more, the visual system operates as a peak detector responding to the peak light energy as if it is exposed to a continuous light source with this peak energy, thus enabling significant energy saving by reducing the pulses duty cycle. Advantageously, persons skilled in the art may define the pulses cycle time and duty cycle that will generate an energy saving high illumination efficacy light source according to embodiments of the present invention.

Because the visual system synthesizes a series of high frequency and low duty cycle light pulses with different colors into a colored continuous light, any color in the visible range may be synthesized by high frequency, low duty cycle train of pulses with a predefined pulse train period and predefined sequence of activation of different color fast response light sources.

Another prior art way to form white light source involves coating an LED of blue color with phosphor of different colors. Unfortunately, these phosphor based white LEDs have medium values CRI (<80). According to embodiments of the present invention, an improved white light source with high CRI (>90) may be formed by adding to a Phosphor based white LED the illumination system described above, where high frequency, low duty cycle train of pulses with a predefined pulse train period and predefined sequence of activation are used to activate at least two different color fast response light sources.

Furthermore, according to embodiment of the present invention, the improved white light source described above may have both high CRI (>90) and high efficacy illumination when activated by a train of high frequency pulses (500 KHz for example) and low duty cycle (10% for example). The improved white light source described above may have energy saving gain proportional to the ratio of the activating pulses peak current to cycle average current.

Advantageously, blue, green and red LEDs are fast response light sources that may be used to construct any light color with high CRI and energy saving high illumination efficacy according to embodiments of the present invention.

Advantageously, other fast response light sources such as plasma light sources may be used according to embodiments of the present invention.

In summary, illumination systems as described above overcome the difficulties and limitations of the prior art illumination systems by constructing an improved white light with high CRI and any other color with energy-saving high illumination efficacy using a high frequency and low duty cycle pulse train, with a predefined pulse train period and predefined sequences of activation of different color fast response light sources.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

What is claimed is:

1. An illumination system, comprising:
at least one fast response light source of each of at least two different colors; and
a mechanism for activating said light sources alternately to generate a train of pulses of said at least two different colors, said pulse train having a frequency above 350 Hz, a duty cycle in the range of 5% to 80%, a predefined sequence of pulses of said at least two different colors within a predefined time period.

2. The illumination system according to claim 1, wherein said mechanism for activating said light sources includes (i) a pulse power supply for generating activating pulses to said at least one fast response light source of each of at least two different colors, and (b) a control unit for managing said pulse power supply.

3. The illumination system according to claim 1, wherein said fast response light sources are light emitting diodes.

4. The illumination system according to claim 1, wherein said fast response light sources are plasma light sources.

5. The illumination system of claim 1, further comprising a phosphor-based white LED that is activated by said mechanism along with said fast response light sources.

6. The illumination system of claim 5, wherein said illumination system has a CRI greater than 90.

7. The illumination system of claim 5, wherein said illumination system has energy saving gain factor proportional to the ratio of the activating pulses peak current to cycle average current.

8. The illumination system according to claim 1, wherein said fast response light sources are grouped in respective arrays and wherein said arrays of light sources are activated alternately.

9. An electronic device comprising the illumination system of claim 1 as a display system thereof.

10. The electronic device according to claim 9, wherein said electronic device is selected from the group consisting of televisions, computers, cellular phones and electronic game devices.

11. A method for synthesizing a light color, the method comprising:
providing fast response light sources of at least two different colors;
defining a train of pulses having a frequency above 350 Hz and a duty cycle in the range of 5% to 80%;
defining a time period and an activation sequence for activating said at least two different colors alternately; and
activating said fast response light sources to emit said train of pulses according to said time period and said activation sequence.

12. The method according to claim 11, wherein said fast response light sources are light emitting diodes.

13. The method according to claim 11, wherein said fast response light sources are plasma light sources.

14. The method according to claim 11, wherein said fast response light sources are grouped in respective arrays and wherein said arrays of light sources are activated alternately.

15. The method according to claim 11, wherein said train of pulses provides color information of a display of an electronic device.

16. The method according to claim 11, wherein said electronic device is selected from the group consisting of televisions, computers, cellular phones and electronic game devices.

17. The method according to claim 11, further comprising providing a phosphor-based white LED and activating said phosphor-based white LED along with the fast response light sources.

18. The method according to claim 17, wherein said synthesized light has CRI greater than 90.

19. The method according to claim 17, wherein said synthesized light has an energy saving gain factor proportional to the ratio of the activating pulses peak current to cycle average current.
